(19) United States
(12) Patent Application Publication
(10) Pub. No.: US 2026/0321465 A1
(43) Pub. Date: Oct. 15, 2026

(54) HEAT-SENSITIVE DEVICE

(71) Applicant: Polytronics Technology Corp., Hsinchu (TW)

(72) Inventors: PO-CHIH SHEN, Zhudong Township (TW); TONG CHENG TSAI, Taoyuan City (TW); TSUNG MIN SU, Hsinchu City (TW)

(21) Appl. No.: 19/245,517

(22) Filed: Jun. 23, 2025

(30) Foreign Application Priority Data
Apr. 14, 2025 (TW) 114113911

(51) Int. Cl. H01C 7/02; H01C 1/14

(52) U.S. Cl. CPC H01C 7/02; H01C 1/1406

(57) ABSTRACT

A ceramic heat-sensitive device includes a ceramic body, an inner electrode layer, and an outer electrode layer. The ceramic body exhibits a positive temperature coefficient (PTC) characteristic and includes a top surface, a bottom surface, a first end surface, and a second end surface. The top surface is disposed opposite to the bottom surface, and the first end surface is disposed opposite to the second end surface. The first end surface and the second end surface connect to the top surface and the bottom surface. The inner electrode layer is positioned on two terminal regions of the top surface, with a gap separating them. The outer electrode layer covers the inner electrode layer.

### BACKGROUND OF THE INVENTION

### (1) Field of the Invention

The present application relates to a ceramic heat-sensitive device, and more specifically, to a ceramic heat-sensitive device having low resistance and excellent resistance jump performance.

### (2) Description of the Related Art

The resistance of a positive temperature coefficient (PTC) device is sensitive to temperature variation, and remains extremely low during normal operation, allowing the circuit to function properly. However, if an over-current or over-temperature event causes the temperature to reach a threshold point or Curie point, the resistance rapidly increases to a high-resistance state (e.g., above 10⁴Ω), a phenomenon commonly referred to as “trip”. As a result, the over-current is eliminated, thereby protecting the cell or the circuit device. PTC devices have been widely used in various types of circuits to prevent damage caused by over-current.

PTC devices can be roughly categorized into two types: Polymer Positive Temperature Coefficient (PPTC) devices and Ceramic Positive Temperature Coefficient (CPTC) devices. A conventional PPTC device cannot easily regain the original resistance after being tripped, i.e., exhibiting worse resistance hysteresis behavior, and it cannot endure high voltages. A conventional CPTC device normally has the advantage of high voltage endurance, and its resistance is closer to the original value after recovery. However, the worse electrical conductivity of the CPTC device, due to the inherent high normal resistance, limits its applications for over-current protection.

In addition, due to differences in PTC materials typically used in these two types of devices, the structural design of their inner electrodes also varies. The PTC material of the PPTC device mainly consists of a polymer and a conductive filler. The polymer and the conductive filler are blended to form an electrically conductive polymer, which is then pressed into a sheet. Copper foils are subsequently placed on the top and bottom of the sheet through a hot-pressing process, forming a three-layer structure. The copper foils can be etched into various patterns as required, thereby forming the inner electrode of the PPTC device. In contrast, the PTC material of the CPTC device mainly consists of a ceramic material. The ceramic material is sintered to form an electrically conductive ceramic substrate, onto which a metal material is then printed and sintered to form the inner electrode. It is understood that, compared with the PPTC device, the design flexibility of the inner electrode in the CPTC device is more limited. A standard design is commonly used in the industry. Please refer to FIG. 1a and FIG. 1b.

FIG. 1a shows a three-dimensional view of a conventional CPTC device, and FIG. 1b shows a cross-sectional view of the CPTC device along the line AA depicted in FIG. 1a. The CPTC device includes a ceramic body 1 (i.e., the electrically conductive ceramic substrate), an inner electrode layer 2, and an outer electrode layer 3. The inner electrode layer 2 is formed on the two end surfaces of the ceramic body 1, and the outer electrode layer 3 covers the inner electrode layer 2 and further wraps around all exposed areas at both terminals of the ceramic body 1. It should be noted that placing the inner electrode layer 2 on both end surfaces creates a significant distance between them, which results in the electrical resistance being too high when the device is not in operation (i.e., in an untripped state). If the ceramic body 1 is shortened to reduce resistance, its dimensions are constrained by practical limits. In fact, as these limits are approached, the device may not only fail to achieve the desired low resistance, but may also exhibit unexpected changes in other electrical characteristics.

Accordingly, there is a need to develop a ceramic heat-sensitive device that offers low resistance while maintaining excellent performance in other electrical characteristics.

### SUMMARY OF THE INVENTION

In accordance with an aspect of the present invention, a ceramic heat-sensitive device includes a ceramic body, an inner electrode layer, and an outer electrode layer. The ceramic body exhibits a positive temperature coefficient (PTC) characteristic and includes a top surface, a bottom surface, a first end surface, and a second end surface. The top surface is disposed opposite to the bottom surface, and the first end surface is disposed opposite to the second end surface. The first end surface and the second end surface connect to the top surface and the bottom surface. The inner electrode layer is disposed on two terminal regions of the top surface. The two terminal regions where the inner electrode layer is disposed are spaced apart by a gap. The outer electrode layer covers the inner electrode layer.

In an embodiment, the ceramic body further includes a first side surface and a second side surface opposite to the first side surface. The first side surface and the second side surface connect to the top surface, the bottom surface, the first end surface, and the second end surface, thereby forming a hexahedron. The outer electrode layer extends and covers the first end surface and the second end surface without covering the first side surface and the second side surface.

In an embodiment, the ceramic heat-sensitive device further includes an insulating layer covering the top surface of the ceramic body. The insulating layer is disposed in the gap between the two terminal regions where the inner electrode layer is disposed.

In an embodiment, the inner electrode layer has an inner electrode's top surface and a first sidewall. The inner electrode's top surface is parallel to the top surface of the ceramic body, and the first sidewall perpendicularly extends from the inner electrode's top surface to the top surface of the ceramic body. The insulating layer extends to the first sidewall, by which the outer electrode layer partially covers the insulating layer and the first sidewall.

In an embodiment, the insulating layer fully covers the first sidewall of the inner electrode layer, and further extends to the inner electrode's top surface, by which the outer electrode layer partially covers the insulating layer and the inner electrode's top surface.

In an embodiment, the inner electrode layer has an inner electrode's top surface and a first sidewall. The inner electrode's top surface is parallel to the top surface of the ceramic body, and the first sidewall perpendicularly extends from the inner electrode's top surface to the top surface of the ceramic body. The outer electrode layer covers the first sidewall and the inner electrode's top surface of the inner electrode layer. The insulating layer extends to the outer electrode layer, and further extends parallel to the first sidewall on the outer electrode layer.

In an embodiment, the insulating layer further covers the bottom surface, the first side surface, and the second side surface of the ceramic body, by which only the insulating layer and the outer electrode layer of the ceramic heat-sensitive device are exposed to external environment.

In an embodiment, the gap ranges from 0.4 mm to 0.45 mm.

In an embodiment, the inner electrode layer has a width extending toward the first end surface and the second end surface, and the width ranges from 0.15 mm to 0.21 mm.

In an embodiment, the inner electrode layer does not include titanium.

In an embodiment, the inner electrode layer is made of a material selected from the group consisting of nickel, chromium, nickel-chromium alloy, nickel-copper alloy, silver, aluminum, and combinations thereof.

In an embodiment, the ceramic body includes a first constituent and a second constituent. The first constituent includes barium, strontium, calcium, and a first trace element. The second constituent includes titanium, manganese, and a second trace element. The first trace element and the second trace element are selected from the group consisting of ytterbium, lanthanum, cerium, antimony, praseodymium, neodymium, samarium, europium, gadolinium, tantalum, erbium, thulium, and combinations thereof. An electrical resistivity of the ceramic body is below 10 Ω·cm.

In an embodiment, the total number of moles of barium, strontium, calcium, and the first trace element is taken as 100%, wherein strontium accounts for 20% to 25%; calcium accounts for 4.5% to 5%; and the first trace element accounts for 0.13% to 0.17%, by which a Curie point of the ceramic body ranges from 85° C. to 91° C.

In an embodiment, the total number of moles of titanium, manganese, and the second trace element is taken as 100%, wherein manganese accounts for 0.01% to 0.03%; and the second trace element accounts for 0.02% to 0.04%.

In an embodiment, the ceramic body has a first electrical resistance at 25° C., and has a second electrical resistance at 125° C. A value of the second electrical resistance divided by the first electrical resistance is at least 10.

In accordance with an aspect of the present invention, a ceramic heat-sensitive device includes a ceramic body, an inner electrode layer, and an outer electrode layer. The ceramic body exhibits a positive temperature coefficient (PTC) characteristic and includes a top surface, a bottom surface, a first end surface, and a second end surface. The top surface is disposed opposite to the bottom surface, and the first end surface is disposed opposite to the second end surface. The first end surface and the second end surface connect to the top surface and the bottom surface. The inner electrode layer is disposed on two terminal regions of the top surface. The two terminal regions where the inner electrode layer is disposed are spaced apart by a gap. The outer electrode layer covers the inner electrode layer and the top surface of the ceramic body without extending to the first end surface and the second end surface.

In an embodiment, the ceramic body further includes a first side surface and a second side surface opposite to the first side surface. The first side surface and the second side surface connect to the top surface, the bottom surface, the first end surface, and the second end surface, thereby forming a hexahedron. The outer electrode layer does not cover the first side surface and the second side surface.

In an embodiment, the ceramic heat-sensitive device further includes an insulating layer covering the top surface of the ceramic body. The insulating layer is disposed in the gap between the two terminal regions where the inner electrode layer is disposed.

In an embodiment, the inner electrode layer has an inner electrode's top surface and a first sidewall. The inner electrode's top surface is parallel to the top surface of the ceramic body, and the first sidewall perpendicularly extends from the inner electrode's top surface to the top surface of the ceramic body. The insulating layer extends to the first sidewall, whereby the outer electrode layer partially covers the insulating layer and the first sidewall.

In an embodiment, the insulating layer fully covers the first sidewall of the inner electrode layer, and further extends to the inner electrode's top surface, by which the outer electrode layer partially covers the insulating layer and the inner electrode's top surface.

In an embodiment, the inner electrode layer has an inner electrode's top surface and a first sidewall. The inner electrode's top surface is parallel to the top surface of the ceramic body, and the first sidewall perpendicularly extends from the inner electrode's top surface to the top surface of the ceramic body. The outer electrode layer covers the first sidewall and the inner electrode's top surface of the inner electrode layer. The insulating layer extends to the outer electrode layer, and further extends parallel to the first sidewall on the outer electrode layer.

In an embodiment, the insulating layer further covers the bottom surface, the first side surface, the second side surface, the first end surface, and the second end surface of the ceramic body.

In an embodiment, the gap ranges from 0.4 mm to 0.45 mm.

In an embodiment, the inner electrode layer has a width extending toward the first end surface and the second end surface, and the width ranges from 0.15 mm to 0.21 mm.

In an embodiment, the inner electrode layer does not include titanium.

In an embodiment, the inner electrode layer is made of a material selected from the group consisting of nickel, chromium, nickel-chromium alloy, nickel-copper alloy, silver, aluminum, and combinations thereof.

In an embodiment, the ceramic body includes a first constituent and a second constituent. The first constituent includes barium, strontium, calcium, and a first trace element. The second constituent includes titanium, manganese, and a second trace element. The first trace element and the second trace element are selected from the group consisting of ytterbium, lanthanum, cerium, antimony, praseodymium, neodymium, samarium, europium, gadolinium, tantalum, erbium, thulium, and combinations thereof. An electrical resistivity of the ceramic body is below 10 Ω·cm.

In an embodiment, the total number of moles of barium, strontium, calcium, and the first trace element is taken as 100%, wherein strontium accounts for 20% to 25%; calcium accounts for 4.5% to 5%; and the first trace element accounts for 0.13% to 0.17%, by which a Curie point of the ceramic body ranges from 85° C. to 91° C.

In an embodiment, the total number of moles of titanium, manganese, and the second trace element is taken as 100%, wherein manganese accounts for 0.01% to 0.03%; and the second trace element accounts for 0.02% to 0.04%.

In an embodiment, the ceramic body has a first electrical resistance at 25° C., and has a second electrical resistance at 125° C. A value of the second electrical resistance divided by the first electrical resistance is at least 10.

### BRIEF DESCRIPTION OF THE DRAWINGS

The present application will be described according to the appended drawings in which:

FIG. 1a and FIG. 1b show a three-dimensional view and a cross-sectional view of a conventional ceramic heat-sensitive device, respectively;

FIG. 2 shows a three-dimensional view of a ceramic heat-sensitive device in accordance with a first aspect of the present invention;

FIG. 3a, FIG. 3b, and FIG. 3c show a cross-sectional view, a top view, and a front view of the ceramic heat-sensitive device in FIG. 2;

FIG. 3d shows an enlarged view of the area indicated by the dashed-line square in FIG. 3a;

FIG. 4 shows a three-dimensional view of a ceramic heat-sensitive device in accordance with a second aspect of the present invention;

FIG. 5a, FIG. 5b, and FIG. 5c show a cross-sectional view, a top view, and a front view of the ceramic heat-sensitive device in FIG. 4;

FIG. 5d shows an enlarged view of the area indicated by the dashed-line square in FIG. 5a;

FIG. 6a, FIG. 6b, FIG. 7a, and FIG. 7b show various embodiments in accordance with the present invention; and

FIG. 8 shows a temperature profile during sintering.

### DETAILED DESCRIPTION OF THE INVENTION

The making and using of the presently preferred illustrative embodiments are discussed in detail below. It should be appreciated, however, that the present application provides many applicable inventive concepts that can be embodied in a wide variety of specific contexts. The specific illustrative embodiments discussed are merely illustrative of specific ways to make and use the invention, and do not limit the scope of the invention.

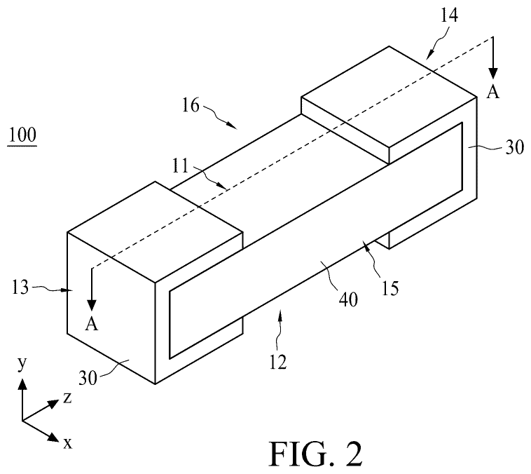

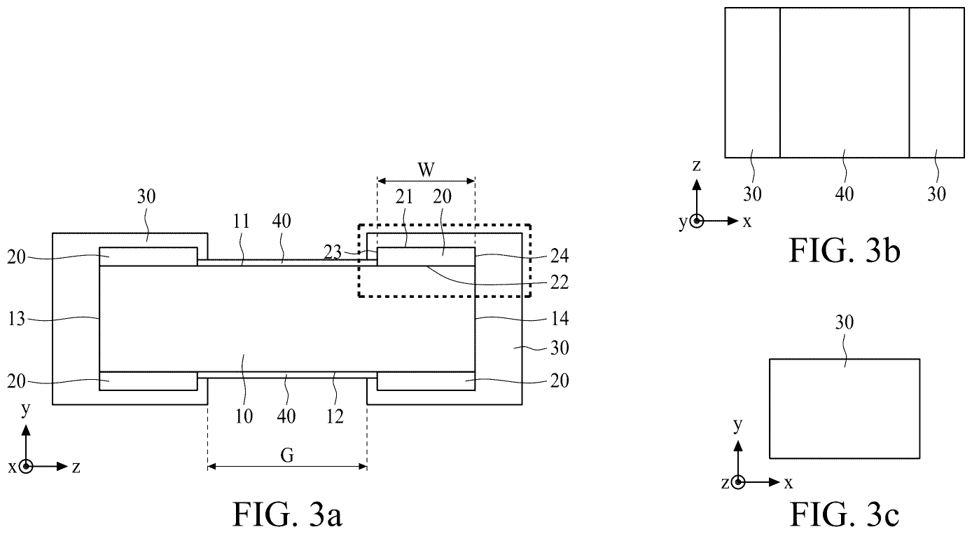

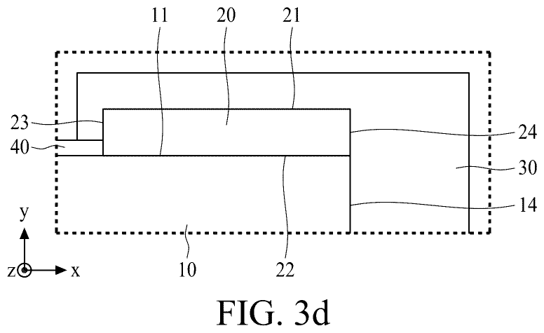

Please refer to FIG. 2 to FIG. 3d, which show different views of a first aspect of a ceramic heat-sensitive device 100 of the present invention. The ceramic heat-sensitive device 100 of the present invention includes a ceramic body 10, an inner electrode layer 20, an outer electrode layer 30, and an insulating layer 40. The ceramic body 10 exhibits a positive temperature coefficient (PTC) characteristic and has the shape of a hexahedron, with a top surface 11, a bottom surface 12, a first end surface 13, a second end surface 14, a first side surface 15, and a second side surface 16. In FIG. 2, the outer electrode layer 30 is located at the two terminals of the ceramic body 10, and it extends from both the top surface 11 and the bottom surface 12 and covers the entire end surfaces (i.e., the first end surface 13 and the second end surface 14), without covering the first side surface 15 and the second side surface 16. The remaining area of the ceramic body 10 exposed to external environment is fully covered by the insulating layer 40. Accordingly, the ceramic heat-sensitive device 100 is formed, in which three faces at each terminal are covered by the outer electrode layer 30.

Please refer to FIG. 3a, which shows a cross-sectional view of the ceramic heat-sensitive device 100 along the dashed line AA in FIG. 2. To enable electrical conduction between the ceramic body 10 and an external power source, the inner electrode layer 20 with excellent ohmic contact should be formed on the ceramic body 10. Therefore, the inner electrode layer 20 may also be referred to as an ohmic contact electrode. The inner electrode layer 20 is made of a material selected from the group consisting of nickel (Ni), chromium (Cr), nickel-chromium (Ni—Cr) alloy, nickel-copper (Ni—Cu) alloy, silver (Ag), aluminum (Al), and combinations thereof, and can be formed through printing, coating, vapor deposition, or other film-forming methods. For example, a paste of nickel-chromium alloy can be printed on the surface and then sintered to form the inner electrode layer 20. In addition, in consideration of material's applicability, the inner electrode layer 20 of the present invention does not include titanium. It is noted that in order to reduce the distance for electrical conduction, the inner electrode layer 20 is not disposed on the first end surface 13 and the second end surface 14. More specifically, the inner electrode layer 20 is disposed on two terminal regions of the top surface 11 and two terminal regions of the bottom surface 12. In each pair, the two terminal regions where the inner electrode layer 20 is disposed are spaced apart by a gap G. That is, on the top surface 11, the inner electrode layer 20 is divided into two independent blocks positioned on the two terminal regions, which are separated by the gap G; and on the bottom surface 12, the inner electrode layer 20 is likewise divided into two independent blocks positioned on the two terminal regions, also separated by the gap G. In other words, on the left side of the cross-sectional view, the inner electrode layer 20 extends rightward along the z-axis from the junctions of the first end surface 13 with the top surface 11 and the bottom surface 12; on the right side of the cross-sectional view, the inner electrode layer 20 extends leftward along the z-axis from the junctions of the second end surface 14 with the top surface 11 and the bottom surface 12. Therefore, the inner electrode layer 20 is disposed on the top surface 11 and the bottom surface 12 without covering the first end surface 13, the second end surface 14, the first side surface 15, and the second side surface 16. It is understood that the inner electrode layer 20 may have either a single-layer or multi-layer structure. In one embodiment, the inner electrode layer 20 has a multi-layer structure, in which multiple layers are stacked along the y-axis, and the material of each layer may be the same or different.

In order to enhance the weather resistance of the ceramic body 10 and insulate the regions not intended for electrical connection, the present invention provides the insulating layer 40 disposed in the gap G between the two terminal regions where the inner electrode layer 20 is disposed. An insulating material may be printed on the regions where no inner electrode layer 20 is present, and then sintered to form the insulating layer 40. Besides the regions covered by the inner electrode layer 20, the insulating layer 40 covers the remaining areas of the top surface 11 and the bottom surface 12, and further extends to cover the first side surface 15 and the second side surface 16 (see FIG. 2). The present invention may further include the outer electrode layer 30 as described above. The outer electrode layer 30 partially covers the insulating layer 40 and fully covers the inner electrode layer 20. The outer electrode layer 30 may be formed by electroplating or chemical plating. For example, nickel (Ni) or tin (Sn) is plated onto the inner electrode layer 20, and the resulting nickel or tin layer may be referred to as the outer electrode layer 30. The outer electrode layer 30 may have either a single-layer or multi-layer structure. In one embodiment, the outer electrode layer 30 has a multi-layer structure, in which the material of each layer may be the same or different.

To clearly describe the configuration among the inner electrode layer 20, the outer electrode layer 30, and the insulating layer 40, please refer to FIG. 3d. FIG. 3d shows an enlarged view of the area indicated by the dashed-line square in FIG. 3a of the ceramic heat-sensitive device 100. The inner electrode layer 20 has an inner electrode's top surface 21, an inner electrode's bottom surface 22, a first sidewall 23, and a second sidewall 24. The inner electrode's top surface 21 is parallel to the top surface 11 of the ceramic body 10, and is opposite to the inner electrode's bottom surface 22. The first sidewall 23 is opposite to the second sidewall 24. The first sidewall 23 and the second sidewall 24 connect to the inner electrode's top surface 21 and the inner electrode's bottom surface 22. That is, the first sidewall 23 perpendicularly extends from the inner electrode's top surface 21 to the top surface 11 of the ceramic body 10, and the second sidewall 24 perpendicularly extends from the inner electrode's top surface 21 to the top surface 11 of the ceramic body 10. The inner electrode's bottom surface 22 is substantially coplanar with the top surface 11 of the ceramic body 10, and the second sidewall 24 is substantially coplanar with the second end surface 14, such that the second sidewall 24 of the inner electrode layer 20 is flush with the second end surface 14 of the ceramic body 10 along the y-axis. In some embodiments, the second sidewall 24 is not flush with the second end surface 14 (not shown), resulting in a step difference along the y-axis between the second sidewall 24 of the inner electrode layer 20 and the second end surface 14 of the ceramic body 10. To prevent infiltration, moisture, or other external factors from affecting the device, the insulating layer 40 is closely fitted to the interface between the electrodes and the ceramic body 10. The insulating layer 40 covers the top surface 11 of the ceramic body 10, and extends to the first sidewall 23 of the inner electrode layer 20 along the x-axis. The outer electrode layer 30 partially covers the insulating layer 40 and the first sidewall 23 of the inner electrode layer 20, and further extends to the inner electrode's top surface 21, the second sidewall 24, and the second end surface 14 of the ceramic body 10. In addition, since the outer electrode layer 30 fully covers the inner electrode layer 20 as described above, it can be seen that the outer electrode layer 30 also completely covers the inner electrode layer 20 when viewed from the yz-plane (See FIG. 2). In this configuration, only the insulating layer 40 and the outer electrode layer 30 of the ceramic heat-sensitive device 100 are exposed to external environment. It is understood that the configuration of all features on the bottom surface 12 of the ceramic body 10 is the same as described above.

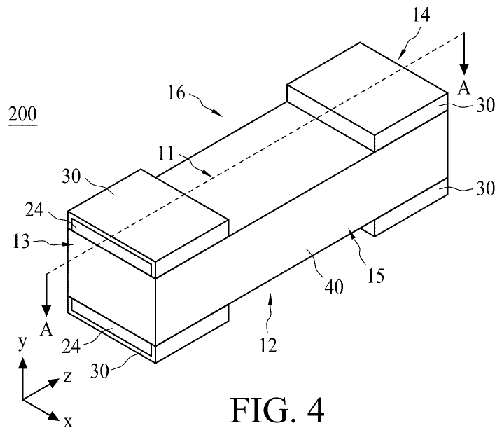

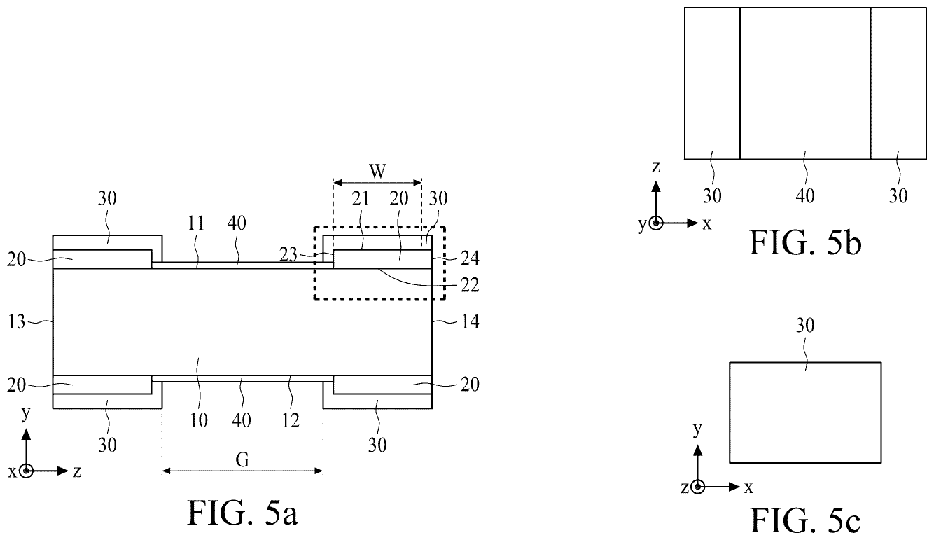

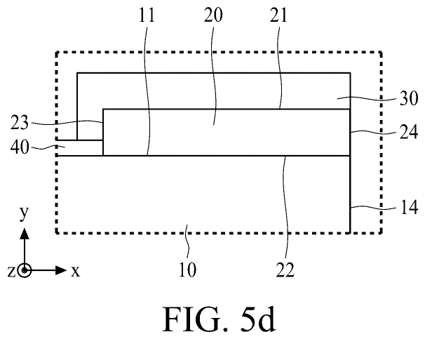

Please refer to FIG. 4 to FIG. 5d, which show different views of a second aspect of a ceramic heat-sensitive device 200 of the present invention. The major difference between the ceramic heat-sensitive device 200 and the ceramic heat-sensitive device 100 lies in the coverage of the outer electrode layer 30. In the ceramic heat-sensitive device 200, the outer electrode layer 30 does not cover the second sidewall 24 of the inner electrode layer 20, nor does it cover the first end surface 13 and the second end surface 14. More specifically, the ceramic heat-sensitive device 200 includes the ceramic body 10, the inner electrode layer 20, the outer electrode layer 30, and the insulating layer 40. The ceramic body 10 exhibits the PTC characteristic and has the shape of the hexahedron, with the top surface 11, the bottom surface 12, the first end surface 13, the second end surface 14, the first side surface 15, and the second side surface 16. In FIG. 4, the outer electrode layer 30 is disposed on two terminals of the top surface 11 and two terminals of the bottom surface 12 of the ceramic body 10. The outer electrode layer 30 does not cover the first side surface 15 and the second side surface 16, nor does it extend to the second sidewall 24 of the inner electrode layer 20. Therefore, the first end surface 13 and the second end surface 14 are not covered by the outer electrode layer 30. Likewise, the remaining area of the ceramic body 10 exposed to external environment is fully covered by the insulating layer 40. Accordingly, the ceramic heat-sensitive device 200 is formed, in which two faces at each terminal are covered by the outer electrode layer 30.

Please refer to FIG. 5a and FIG. 5d. FIG. 5a shows a cross-sectional view of the ceramic heat-sensitive device 200 along the dashed line AA in FIG. 4. FIG. 5d shows an enlarged view of the area indicated by the dashed-line square in FIG. 5a of the ceramic heat-sensitive device 200. The inner electrode layer 20 has the inner electrode's top surface 21, the inner electrode's bottom surface 22, the first sidewall 23, and the second sidewall 24. The inner electrode's top surface 21 is parallel to the top surface 11 of the ceramic body 10, and is opposite to the inner electrode's bottom surface 22. The first sidewall 23 is opposite to the second sidewall 24. The first sidewall 23 and the second sidewall 24 connect to the inner electrode's top surface 21 and the inner electrode's bottom surface 22. The inner electrode's bottom surface 22 is substantially coplanar with the top surface 11 of the ceramic body 10. The first sidewall 23 perpendicularly extends from the inner electrode's top surface 21 to the top surface 11 of the ceramic body 10, and the second sidewall 24 perpendicularly extends from the inner electrode's top surface 21 to the top surface 11 of the ceramic body 10. The second sidewall 24 is substantially coplanar with the second end surface 14, such that the second sidewall 24 of the inner electrode layer 20 is flush with the second end surface 14 of the ceramic body 10 along the y-axis. Therefore, the second sidewall 24 is exposed to external environment. In some embodiments, the second sidewall 24 is not flush with the second end surface 14 (not shown), resulting in a step difference along the y-axis between the second sidewall 24 of the inner electrode layer 20 and the second end surface 14 of the ceramic body 10; as a result, the second sidewall 24 may subsequently be covered by the outer electrode layer 30 during the manufacturing process. Likewise, to prevent infiltration, moisture, or other external factors from affecting the device, the insulating layer 40 is closely fitted to the interface between the electrodes and the ceramic body 10. The insulating layer 40 covers the top surface 11 of the ceramic body 10, and extends to the first sidewall 23 of the inner electrode layer 20 along the x-axis. The outer electrode layer 30 partially covers the insulating layer 40 and the first sidewall 23 of the inner electrode layer 20, further extends to the inner electrode's top surface 21, and terminates at the junction between the inner electrode's top surface 21 and the second sidewall 24. Therefore, the outer electrode layer 30 does not extend to the second end surface 14. In addition, it can be seen that the outer electrode layer 30 also fully covers the inner electrode layer 20 when viewed from the yz-plane (See FIG. 4). In this configuration, only the second sidewall 24 of the inner electrode layer 20, the insulating layer 40, and the outer electrode layer 30 of the ceramic heat-sensitive device 200 are exposed to external environment. It is understood that components identical to those described earlier are denoted by the same reference numerals and may have the same functions and configurations as previously described. To avoid redundancy, the remaining components will not be described again herein.

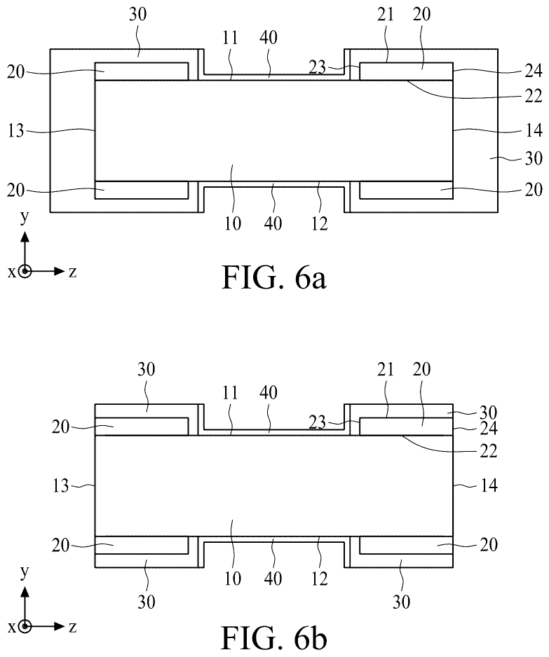

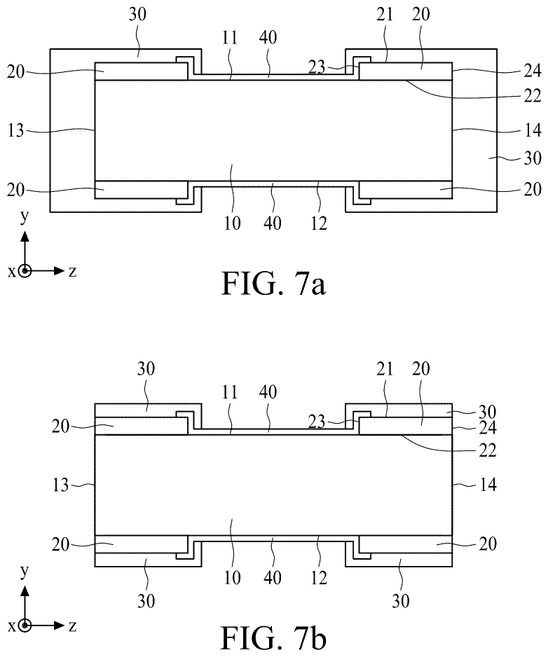

The configuration of the layers in the present invention may vary as required. Please refer to the various embodiments shown in FIG. 6a to FIG. 7b.

FIG. 6a and FIG. 6b show cross-sectional views of the ceramic heat-sensitive device 100 and the ceramic heat-sensitive device 200, respectively. Compared with FIG. 3a, the insulating layer 40 in FIG. 6a covers an inner sidewall of the outer electrode layer 30. Similarly, compared with FIG. 5a, the insulating layer 40 in FIG. 6b covers an inner sidewall of the outer electrode layer 30. More specifically, the outer electrode layer 30 covers the inner electrode's top surface 21 of the inner electrode layer 20, and further extends to the top surface 11 of the ceramic body 10 along the y-axis, so as to fully cover the first sidewall 23 of the inner electrode layer 20. The insulating layer 40 on the top surface 11 extends to the outer electrode layer 30 along the z-axis, and further extends parallel to the first sidewall 23 of the inner electrode layer 20 along the y-axis on the outer electrode layer 30. Therefore, the insulating layer 40 is formed on the opposing inner sidewalls of the outer electrode layer 30, effectively preventing arcing. It is understood that components identical to those described earlier are denoted by the same reference numerals and may have the same functions and configurations as previously described. To avoid redundancy, the remaining components will not be described again herein.

FIG. 7a and FIG. 7b show cross-sectional views of the ceramic heat-sensitive device 100 and the ceramic heat-sensitive device 200, respectively. Compared with FIG. 3a, the insulating layer 40 in FIG. 7a further covers an inner sidewall and a part of the top surface of the inner electrode layer 20. Similarly, compared with FIG. 5a, the insulating layer 40 in FIG. 7b further covers an inner sidewall and a part of the top surface of the inner electrode layer 20. More specifically, the insulating layer 40 extends along the z-axis on the top surface 11 to the first sidewall 23 of the inner electrode layer 20, then continues to extend along the y-axis to fully cover the first sidewall 23, and finally extends along the z-axis to the inner electrode's top surface 21. In this configuration, the outer electrode layer 30 is not in physical contact with the first sidewall 23 of the inner electrode layer 20, with the insulating layer 40 disposed between them. The insulating layer 40 extends deeper into the interface between the inner and outer electrodes, providing enhanced protection. It is understood that components identical to those described earlier are denoted by the same reference numerals and may have the same functions and configurations as previously described. To avoid redundancy, the remaining components will not be described again herein.

The present invention further improves the material composition of the ceramic body 10 in conjunction with the aforementioned structural design.

TABLE 1

| | Composition (mol %) | | | | | | | |
|---|---|---|---|---|---|---|---|---|
| | First constituent | | | Second constituent | | Electrical characteristic | | |
| | (Ba + Sr + Ca + R₁ = 100%) | | | (Ti + Mn + R₂ = 100%) | | ρ | T_{c} | |
| Group | Sr | Ca | R₁ | Mn | R₂ | (Ω · cm) | (° C.) | R₁₂₅/R₂₅ |
| C1 | 15 | 3.0 | 0.13 | 0.01 | 0.02 | 12.63 | 103 | 42.5 |
| E1 | 20 | 4.5 | 0.13 | 0.01 | 0.02 | 8.16 | 91 | 45.3 |
| E2 | 23 | 4.5 | 0.13 | 0.01 | 0.02 | 8.43 | 88 | 46.5 |
| E3 | 25 | 4.5 | 0.13 | 0.01 | 0.02 | 8.38 | 86 | 45.8 |
| E4 | 20 | 4.8 | 0.13 | 0.01 | 0.02 | 8.62 | 89 | 42.4 |
| E5 | 20 | 5.0 | 0.13 | 0.01 | 0.02 | 7.98 | 91 | 43.4 |
| E6 | 25 | 5.0 | 0.13 | 0.01 | 0.02 | 9.03 | 85 | 46.5 |
| E7 | 20 | 4.5 | 0.15 | 0.01 | 0.02 | 6.49 | 89 | 39.8 |
| E8 | 20 | 4.5 | 0.17 | 0.01 | 0.02 | 9.65 | 90 | 46.1 |
| E9 | 25 | 5.0 | 0.17 | 0.01 | 0.02 | 9.88 | 86 | 42.5 |
| C2 | 30 | 4.5 | 0.17 | 0.01 | 0.02 | 8.65 | 72 | 44.6 |
| C3 | 25 | 5.0 | 0.20 | 0.01 | 0.02 | 18.31 | 88 | 49.8 |
| E10 | 20 | 4.5 | 0.15 | 0.02 | 0.02 | 7.89 | 88 | 56.5 |
| E11 | 20 | 4.5 | 0.15 | 0.03 | 0.02 | 10.01 | 86 | 86.8 |
| C4 | 20 | 4.5 | 0.15 | 0.04 | 0.02 | 23.8 | 84 | 103.8 |
| C5 | 20 | 4.5 | 0.15 | 0.02 | 0.01 | 13.64 | 91 | 62.3 |
| E12 | 20 | 4.5 | 0.15 | 0.02 | 0.03 | 7.28 | 90 | 53.2 |
| E13 | 20 | 4.5 | 0.15 | 0.01 | 0.04 | 9.24 | 89 | 41.6 |
| C6 | 20 | 4.5 | 0.15 | 0.01 | 0.05 | 16.85 | 88 | 47.2 |

R₁ refers to the first trace element. R₂ refers to the second trace element. ρ refers to the electrical resistivity. T_{c} refers to the Curie point, defined as the temperature at which the resistance is twice the resistance measured at 25° C. To meet the industrial requirements, the desired Curie point (T_{c}) should be controlled within the range of 85° C. to 90° C. R₁₂₅/R₂₅ refers to the resistance jump ratio, defined as the ratio of the resistance at 125° C. divided by the resistance at 25° C. In other words, the ceramic body has a first electrical resistance at 25° C. and a second electrical resistance at 125° C. The ratio of the second electrical resistance divided by the first electrical resistance is expressed as R₁₂₅/R₂₅.

The manufacturing process for the ceramic body 10 is described below.

First, barium carbonate (BaCO₃), strontium carbonate (SrCO₃), calcium carbonate (CaCO₃), titanium dioxide (TiO₂), manganese dioxide (MnO₂), trivalent and pentavalent elements, along with a dispersant and water, are mixed and milled using a ball mill to form a slurry. The trivalent and pentavalent elements are selected from the group consisting of ytterbium (Y), lanthanum (La), cerium (Ce), antimony (Sb), praseodymium (Pr), neodymium (Nd), samarium (Sm), europium (Eu), gadolinium (Gd), tantalum (Ta), erbium (Er), thulium (Tm), and combinations thereof. The slurry is filtered and dried, then sintered at 800° C. to 1000° C., forming a ceramic powder. The ceramic powder is mixed with a binder and formed into numerous ceramic granules using a granulator. These ceramic granules are hot-pressed into a ceramic green body, which is subsequently placed in a sintering furnace and sintered in air to form the ceramic body 10. The sintering temperature is 1320° C., and the duration of it is one hour. In the sintering furnace, the sintering atmosphere contains 21% oxygen. After analyzing the element composition and electrical characteristics of the ceramic body 10, the results are shown in Table 1.

As shown in Table 1, the ceramic body 10 includes the first constituent and the second constituent.

In the first constituent, the total number of moles of barium, strontium, calcium, and the first trace element is taken as 100%, with the proportions of strontium, calcium, and the first trace element adjusted accordingly. Strontium and barium are commonly used to adjust the Curie point, and calcium serves as a grain refiner. In the second constituent, the total number of moles of titanium, manganese, and the second trace element is taken as 100%, with the proportions of manganese and the second trace element adjusted accordingly. Manganese can be used to adjust the degree of the resistance jump.

Please refer to the comparative example C1 and the embodiments E1 to E6. Regarding the comparative example C1 and the embodiments E1 to E6, the main difference lies in the proportion between strontium and calcium. In the embodiments E1 to E6, the proportions of strontium and calcium are adjusted to be at least 20% and at least 4.5%, respectively. In the comparative example C1, the proportions of strontium and calcium are 15% and 3% respectively. As a result, in the embodiments E1 to E6, the electrical resistivity (ρ) significantly decreases to below 9.03 Ω·cm; the Curie point (T_{c}) remains within the range of 85° C. to 90° C.; and the resistance jump ratio (R₁₂₅/R₂₅) generally exceeds 43. In contrast, in the comparative example C1, the electrical resistivity (ρ) is significantly greater than 10 Ω·cm, and the resistance jump ratio (R₁₂₅/R₂₅) is lower.

Please refer to the embodiments E7 to E9 and the comparative examples C2 to C3. In the embodiments E7 to E9, the proportions of strontium and calcium are maintained within a range similar to that in the embodiments E1 to E6, while the proportion of the second trace element is slightly increased. Regarding the comparative example C2 and the embodiments E7 to E9, the main difference lies in the proportion of strontium, which is higher in the comparative example C2 at 30%. Regarding the comparative example C3 and the embodiments E7 to E9, the main difference lies in the proportion of the second trace element, which is higher in the comparative example C3 at 0.2%. As a result, in the embodiments E7 to E9, the electrical resistivity (ρ) can be controlled to be below 10 Ω·cm; the Curie point (T_{c}) ranges around 90° C.; and the resistance jump ratio (R₁₂₅/R₂₅) generally exceeds 40. In contrast, the Curie point (T_{c}) in the comparative example C2 is too low to meet the required protection temperature, although it maintains a low electrical resistivity (ρ). As for the comparative example C3, its electrical resistivity (ρ) is significantly higher, making it difficult for current to pass through when the protection device is not in operation.

Please refer to the embodiments E10 to E11 and the comparative example C4. Regarding the embodiments E10 to E11 and the comparative example C4, the main difference lies in the proportion of manganese. In the embodiments E10 to E11, the proportion of manganese ranges from 0.02% to 0.03%. In the comparative example C4, the proportion of manganese is relatively higher, which is 0.04%. As a result, in the embodiments E10 to E11, the electrical resistivity (ρ) can be effectively reduced, while maintaining a high resistance jump ratio (R₁₂₅/R₂₅). In the comparative example C4, the electrical resistivity (ρ) is significantly higher at 23.8 Ω·cm, which compromises the electrical conduction of the protected apparatus during normal operation.

Please refer to the embodiment E12 and the comparative example C5. Regarding the embodiment E12 and the comparative example C5, the main difference lies in the proportion of the second trace element. The proportion of the second trace element in the embodiment E12 is 0.03%, while the proportion of the second trace element in the comparative example C5 is lower at 0.01%. The results show that the embodiment E12 still maintains a lower electrical resistivity (ρ), whereas the electrical resistivity (ρ) of the comparative example C5 is excessively high.

Please refer to the embodiment E13 and the comparative example C6. Compared with the aforementioned embodiment E12 and comparative example C5, the embodiment E13 and the comparative example C6 are used to investigate the influence of the second trace element under a lower manganese content (0.01%). The proportion of the second trace element in the embodiment E13 is 0.04%, while in the comparative example C6, it is higher at 0.05%. The results show that when the proportion of manganese is fixed at 0.01%, an optimal low electrical resistivity (ρ) can be achieved by adjusting the proportion of the second trace element to 0.04%.

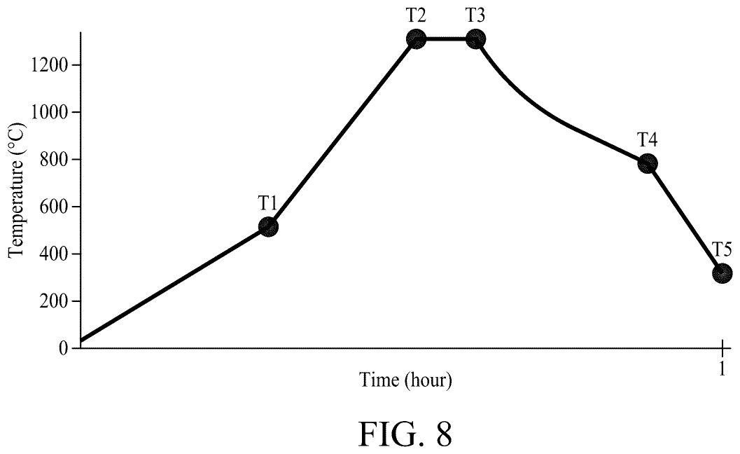

In the sintering process, the present invention further involves conducting tests by adjusting the oxygen content in the sintering atmosphere. Please refer to Table 2 and FIG. 8.

TABLE 2

| | | | | | | Oxygen content in sintering | | | | | | |
|---|---|---|---|---|---|---|---|---|---|---|---|---|
| | | | | | | atmosphere (%) | | | | | | |
| | | | | | | | High- | | | | | |
| | | | | | | Heating | temperature | Cooling | | Electrical characteristic | | |
| | Composition (mol %) | | | | | stage | stage | stage | | ρ | T_{c} | |
| Group | Sr | Ca | R₁ | Mn | R₂ | T1-T2 | T2-T3 | T3-T4 | T4-T5 | (Ω · cm) | (° C.) | R₁₂₅/R₂₅ |
| E7 | 20 | 4.5 | 0.15 | 0.01 | 0.02 | 21% | 21% | 21% | 21% | 6.49 | 89 | 39.8 |
| E10 | 20 | 4.5 | 0.15 | 0.02 | 0.02 | 21% | 21% | 21% | 21% | 7.89 | 88 | 56.5 |
| E12 | 20 | 4.5 | 0.15 | 0.02 | 0.03 | 21% | 21% | 21% | 21% | 7.28 | 90 | 53.2 |
| C7 | 20 | 4.5 | 0.15 | 0.01 | 0.02 | 3% | 3% | 3% | 3% | 1.53 | — | |
| C8 | 20 | 4.5 | 0.15 | 0.02 | 0.02 | 3% | 3% | 3% | 3% | 1.03 | — | |
| C9 | 20 | 4.5 | 0.15 | 0.02 | 0.03 | 3% | 3% | 3% | 3% | 1.26 | — | |
| E14 | 20 | 4.5 | 0.15 | 0.01 | 0.02 | 10% | 3% | 15% | 21% | 2.88 | 86 | 16.6 |
| E15 | 20 | 4.5 | 0.15 | 0.02 | 0.02 | 10% | 3% | 15% | 21% | 3.02 | 85 | 21.3 |
| E16 | 20 | 4.5 | 0.15 | 0.02 | 0.03 | 10% | 3% | 15% | 21% | 3.35 | 86 | 19.6 |
| E17 | 20 | 4.5 | 0.15 | 0.01 | 0.02 | 7% | 3% | 15% | 21% | 2.76 | 85 | 15.9 |
| E18 | 20 | 4.5 | 0.15 | 0.02 | 0.02 | 7% | 3% | 15% | 21% | 2.89 | 86 | 18.6 |
| E19 | 20 | 4.5 | 0.15 | 0.02 | 0.03 | 7% | 3% | 15% | 21% | 3.02 | 85 | 17.3 |
| C10 | 20 | 4.5 | 0.15 | 0.01 | 0.02 | 3% | 3% | 5% | 21% | 3.02 | 82 | 6.3 |
| C11 | 20 | 4.5 | 0.15 | 0.02 | 0.02 | 3% | 3% | 5% | 21% | 2.95 | 80 | 4.8 |
| C12 | 20 | 4.5 | 0.15 | 0.02 | 0.03 | 3% | 3% | 5% | 21% | 2.86 | 83 | 6.4 |

As shown in FIG. 8, the duration of the sintering time is one hour, and the critical temperature points during the sintering process are referred to as T1, T2, T3, T4, and T5, corresponding to 500° C., 1320° C., 1320° C., 800° C., and 300° C., respectively. The temperature profile consists of three stages: 500° C. to 1320° C. (T1-T2) is the heating stage; 1320° C. to 1320° C. (T2-T3) is the high-temperature stage; and 1320° C. to 800° C. (T3-T4) and 800° C. to 300° C. (T4-T5) are the cooling stage. In this test, based on the aforementioned composition, the electrical resistivity (ρ) can be further reduced by adjusting the oxygen content in the sintering atmosphere.

Please refer to the embodiments E7, E10, and E12, and the comparative examples C7 to C9. In these groups, the oxygen content is maintained consistently across the heating stage, the high-temperature stage, and the cooling stage. The oxygen content in the embodiments E7, E10, and E12 is 21%, and the oxygen content in the comparative examples C7 to C9 is 3%. The results show that the oxygen content in the comparative examples C7 to C9 is too low to form sufficient oxide layers on the ceramic particles of the ceramic body 11, resulting in the absence of the property of resistance jump. Although the ceramic body 11 has a lower electrical resistivity (ρ), it cannot function as an over-current protection device without the property of resistance jump.

Please refer to the embodiments E14 to E19, and the comparative examples C10 to C12. In these groups, the oxygen content in the heating stage, the high-temperature stage, and the earlier part of the cooling stage (T3-T4) is adjusted to be lower than 21%, while the oxygen content in the later part of the cooling stage (T4-T5) is maintained at a high level of 21%. More specifically, in the embodiments E14 to E19, the oxygen content profile in the heating stage, the high-temperature stage, and the earlier part of the cooling stage (T3-T4) is high-low-high, with the oxygen content in the heating stage being higher than 7% and in the earlier part of the cooling stage (T3-T4) being 15%. In contrast, in the comparative examples C10 to C12, the oxygen content profile in the heating stage, the high-temperature stage, and the earlier part of the cooling stage (T3-T4) is low-low-high, with the oxygen content in both the heating stage and the earlier part of the cooling stage (T3-T4) being lower than 5%. As a result, in the embodiments E14 to E19, the electrical resistivity (ρ) significantly decreases to below 10 Ω·cm; the Curie point (T_{c}) is either 85° C. or 86° C.; and the resistance jump ratio (R₁₂₅/R₂₅) ranges from 15.9 to 21.3. In contrast, in the comparative examples C10 to C12, the resistance jump ratio (R₁₂₅/R₂₅) is too low to effectively cut off the current flow during device operation, although its electrical resistivity (ρ) and the Curie point (T_{c}) are similar to those in the embodiments.

TABLE 3

| | | | Structural design | | | | |
|---|---|---|---|---|---|---|---|
| | | | Number of | Width of | Gap of | Electrical | |
| | Ceramic body | | faces covered | inner | inner | characteristic | |
| | | ρ | by outer | electrode | electrode | Resistance | |
| Group | Source | (Ω · cm) | electrode | (mm) | (mm) | (Ω) | R₁₂₅/R₂₅ |
| E20 | E12 | 7.33 | 2 | 0.151 | 0.45 | 398 | 22.7 |
| E21 | | 7.25 | 3 | 0.153 | 0.45 | 256 | 19.6 |
| C13 | | 7.28 | 5 | 0.148 | 0.45 | 332 | 20.4 |
| E22 | | 7.35 | 2 | 0.202 | 0.40 | 346 | 20.8 |
| E23 | | 7.32 | 3 | 0.205 | 0.40 | 219 | 18.5 |
| C14 | | 7.25 | 5 | 0.198 | 0.40 | 324 | 19.8 |
| E24 | E17 | 2.86 | 2 | 0.153 | 0.45 | 172 | 18.8 |
| E25 | | 2.90 | 3 | 0.146 | 0.45 | 113 | 16.4 |
| C15 | | 2.98 | 5 | 0.155 | 0.45 | 135 | 17.3 |
| E26 | | 2.93 | 2 | 0.197 | 0.40 | 134 | 17.5 |
| E27 | | 2.85 | 3 | 0.205 | 0.40 | 101 | 15.8 |
| C16 | | 2.84 | 5 | 0.208 | 0.40 | 141 | 16.3 |

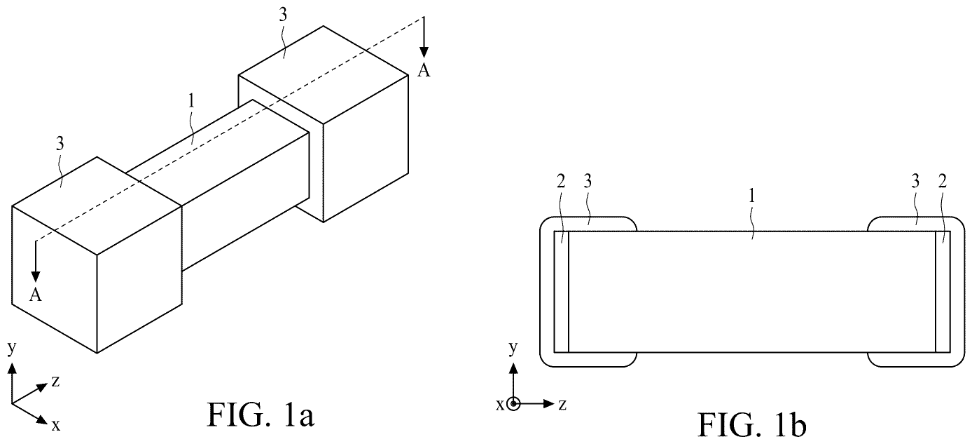

In Table 3, the ceramic body 11, manufactured as described above, can be applied to different structures. The number of faces covered by the outer electrode refers to the number of surfaces at one terminal of the device that are covered by the outer electrode layer 3 or 30. For example, the outer electrode layer 30 in FIG. 2 covers the top surface 11, the first end surface 13, and the bottom surface 12, resulting in a total of three faces being covered; thus, the number of faces covered by the outer electrode is 3. The outer electrode layer 30 in FIG. 4 covers the top surface 11 and the bottom surface 12, resulting in a total of two faces being covered; thus, the number of faces covered by the outer electrode is 2. The outer electrode layer 3 in FIG. 1a covers all the surfaces at one terminal, resulting in a total of five faces being covered; thus, the number of faces covered by the outer electrode is 5.

The width of the inner electrode refers to the width of the inner electrode layer at one terminal, as seen from a cross-sectional view, for example, the width W as shown in FIG. 3a and FIG. 5a. The gap of the inner electrode is the gap G, as previously mentioned.

The ceramic bodies in the groups E20, E21, C13, E22, E23, and C14 are derived from the embodiment E12.

Please refer to the embodiment E20, the embodiment E21, and the comparative example C13. The gap of the inner electrode is consistently 0.45 mm, and the width of the inner electrode ranges from 0.148 mm to 0.153 mm. The results show that, compared with the conventional structural design, the present invention exhibits lower electrical resistance when using the ceramic heat-sensitive device 100 of the first aspect (i.e., the embodiment E21), and a better resistance jump ratio (R₁₂₅/R₂₅) when using the ceramic heat-sensitive device 200 of the second aspect (i.e., the embodiment E20).

Please refer to the embodiment E22, the embodiment E23, and the comparative example C14. The gap of the inner electrode is consistently 0.4 mm, and the width of the inner electrode ranges from 0.198 mm to 0.205 mm. Similarly, the results show that, compared with the conventional structural design, the present invention exhibits lower electrical resistance when using the ceramic heat-sensitive device 100 of the first aspect (i.e., the embodiment E23), and a better resistance jump ratio (R₁₂₅/R₂₅) when using the ceramic heat-sensitive device 200 of the second aspect (i.e., the embodiment E22).

The ceramic bodies in the groups E24, E25, C15, E26, E27, and C16 are derived from the embodiment E17.

Please refer to the embodiment E24, the embodiment E25, and the comparative example C15. The gap of the inner electrode is consistently 0.45 mm, and the width of the inner electrode ranges from 0.146 mm to 0.155 mm. The results show that, compared with the conventional structural design, the present invention exhibits lower electrical resistance when using the ceramic heat-sensitive device 100 of the first aspect (i.e., the embodiment E25), and a better resistance jump ratio (R₁₂₅/R₂₅) when using the ceramic heat-sensitive device 200 of the second aspect (i.e., the embodiment E24).

Please refer to the embodiment E26, the embodiment E27, and the comparative example C16. The gap of the inner electrode is consistently 0.4 mm, and the width of the inner electrode ranges from 0.197 mm to 0.208 mm. Similarly, the results show that, compared with the conventional structural design, the present invention exhibits lower electrical resistance when using the ceramic heat-sensitive device 100 of the first aspect (i.e., the embodiment E27), and a better resistance jump ratio (R₁₂₅/R₂₅) when using the ceramic heat-sensitive device 200 of the second aspect (i.e., the embodiment E26).

From the above, the design of the ceramic heat-sensitive device of the present invention can achieve low electrical resistivity, an appropriate Curie point, and a good resistance jump ratio. At the same time, further improvements in electrical characteristics can be made by adjusting the material composition of the ceramic body.

The above-described embodiments of the present invention are intended to be illustrative only. Numerous alternative embodiments may be devised by persons skilled in the art without departing from the scope of the following claims.

What is claimed is:

1. A ceramic heat-sensitive device, comprising:
a ceramic body exhibiting a positive temperature coefficient (PTC) characteristic and comprising a top surface, a bottom surface, a first end surface, and a second end surface, wherein the top surface is disposed opposite to the bottom surface, and the first end surface is disposed opposite to the second end surface, wherein the first end surface and the second end surface are connected to the top surface and the bottom surface;
an inner electrode layer disposed on two terminal regions of the top surface, wherein the two terminal regions where the inner electrode layer is disposed are spaced apart by a gap; and
an outer electrode layer covering the inner electrode layer.

2. The ceramic heat-sensitive device of claim 1, wherein the ceramic body further comprises a first side surface and a second side surface opposite to the first side surface, wherein the first side surface and the second side surface connect to the top surface, the bottom surface, the first end surface, and the second end surface, thereby forming a hexahedron, wherein the outer electrode layer extends and covers the first end surface and the second end surface without covering the first side surface and the second side surface.

3. The ceramic heat-sensitive device of claim 2, further comprising an insulating layer covering the top surface of the ceramic body, wherein the insulating layer is disposed in the gap between the two terminal regions where the inner electrode layer is disposed.

4. The ceramic heat-sensitive device of claim 3, wherein the inner electrode layer has an inner electrode's top surface and a first sidewall, wherein:
the inner electrode's top surface is parallel to the top surface of the ceramic body, and the first sidewall perpendicularly extends from the inner electrode's top surface to the top surface of the ceramic body; and
the insulating layer extends to the first sidewall, whereby the outer electrode layer partially covers the insulating layer and the first sidewall.

5. The ceramic heat-sensitive device of claim 4, wherein the insulating layer fully covers the first sidewall of the inner electrode layer, and further extends to the inner electrode's top surface, whereby the outer electrode layer partially covers the insulating layer and the inner electrode's top surface.

6. The ceramic heat-sensitive device of claim 3, wherein the inner electrode layer has an inner electrode's top surface and a first sidewall, wherein:
the inner electrode's top surface is parallel to the top surface of the ceramic body, and the first sidewall perpendicularly extends from the inner electrode's top surface to the top surface of the ceramic body; and
the outer electrode layer covers the first sidewall and the inner electrode's top surface of the inner electrode layer; and
the insulating layer extends to the outer electrode layer, and further extends parallel to the first sidewall on the outer electrode layer.

7. The ceramic heat-sensitive device of claim 3, wherein the insulating layer further covers the bottom surface, the first side surface, and the second side surface of the ceramic body, whereby only the insulating layer and the outer electrode layer of the ceramic heat-sensitive device are exposed to external environment.

8. The ceramic heat-sensitive device of claim 1, wherein the gap ranges from 0.4 mm to 0.45 mm.

9. The ceramic heat-sensitive device of claim 1, wherein the inner electrode layer has a width extending toward the first end surface and the second end surface, and the width ranges from 0.15 mm to 0.21 mm.

10. The ceramic heat-sensitive device of claim 1, wherein the inner electrode layer does not comprise titanium.

11. The ceramic heat-sensitive device of claim 10, wherein the inner electrode layer is made of a material selected from the group consisting of nickel, chromium, nickel-chromium alloy, nickel-copper alloy, silver, aluminum, and combinations thereof.

12. The ceramic heat-sensitive device of claim 1, wherein the ceramic body comprises a first constituent and a second constituent, wherein:
the first constituent comprises barium, strontium, calcium, and a first trace element;
the second constituent comprises titanium, manganese, and a second trace element;
the first trace element and the second trace element are selected from the group consisting of ytterbium, lanthanum, cerium, antimony, praseodymium, neodymium, samarium, europium, gadolinium, tantalum, erbium, thulium, and combinations thereof; and
an electrical resistivity of the ceramic body is below 10 Ω·cm.

13. The ceramic heat-sensitive device of claim 12, wherein the total number of moles of barium, strontium, calcium, and the first trace element is taken as 100%, wherein:
strontium accounts for 20% to 25%;
calcium accounts for 4.5% to 5%; and
the first trace element accounts for 0.13% to 0.17%, whereby a Curie point of the ceramic body ranges from 85° C. to 91° C.

14. The ceramic heat-sensitive device of claim 12, wherein the total number of moles of titanium, manganese, and the second trace element is taken as 100%, wherein:
manganese accounts for 0.01% to 0.03%; and
the second trace element accounts for 0.02% to 0.04%.

15. The ceramic heat-sensitive device of claim 14, wherein:
the ceramic body has a first electrical resistance at 25° C.;
the ceramic body has a second electrical resistance at 125° C.; and
a value of the second electrical resistance divided by the first electrical resistance is at least 10.

16. A ceramic heat-sensitive device, comprising:
a ceramic body exhibiting a positive temperature coefficient (PTC) characteristic and comprising a top surface, a bottom surface, a first end surface, and a second end surface, wherein the top surface is disposed opposite to the bottom surface, and the first end surface is disposed opposite to the second end surface, wherein the first end surface and the second end surface connect to the top surface and the bottom surface;
an inner electrode layer disposed on two terminal regions of the top surface, wherein the two terminal regions where the inner electrode layer is disposed are spaced apart by a gap; and
an outer electrode layer covering the inner electrode layer and the top surface of the ceramic body without extending to the first end surface and the second end surface.

17. The ceramic heat-sensitive device of claim 16, wherein the ceramic body further comprises a first side surface and a second side surface opposite to the first side surface, wherein the first side surface and the second side surface connect to the top surface, the bottom surface, the first end surface, and the second end surface, thereby forming a hexahedron, wherein the outer electrode layer does not cover the first side surface and the second side surface.

18. The ceramic heat-sensitive device of claim 17, further comprising an insulating layer covering the top surface of the ceramic body, wherein the insulating layer is disposed in the gap between the two terminal regions where the inner electrode layer is disposed.

19. The ceramic heat-sensitive device of claim 18, wherein the inner electrode layer has an inner electrode's top surface and a first sidewall, wherein:
the inner electrode's top surface is parallel to the top surface of the ceramic body, and the first sidewall perpendicularly extends from the inner electrode's top surface to the top surface of the ceramic body; and
the insulating layer extends to the first sidewall, whereby the outer electrode layer partially covers the insulating layer and the first sidewall.

20. The ceramic heat-sensitive device of claim 19, wherein the insulating layer fully covers the first sidewall of the inner electrode layer, and further extends to the inner electrode's top surface, whereby the outer electrode layer partially covers the insulating layer and the inner electrode's top surface.

21. The ceramic heat-sensitive device of claim 18, wherein the inner electrode layer has an inner electrode's top surface and a first sidewall, wherein:
the inner electrode's top surface is parallel to the top surface of the ceramic body, and the first sidewall perpendicularly extends from the inner electrode's top surface to the top surface of the ceramic body;
the outer electrode layer covers the first sidewall and the inner electrode's top surface of the inner electrode layer; and
the insulating layer extends to the outer electrode layer, and further extends parallel to the first sidewall on the outer electrode layer.

22. The ceramic heat-sensitive device of claim 18, wherein the insulating layer further covers the bottom surface, the first side surface, the second side surface, the first end surface, and the second end surface of the ceramic body.

23. The ceramic heat-sensitive device of claim 16, wherein the gap ranges from 0.4 mm to 0.45 mm.

24. The ceramic heat-sensitive device of claim 16, wherein the inner electrode layer has a width extending toward the first end surface and the second end surface, and the width ranges from 0.15 mm to 0.21 mm.

25. The ceramic heat-sensitive device of claim 16, wherein the inner electrode layer does not comprise titanium.

26. The ceramic heat-sensitive device of claim 25, wherein the inner electrode layer is made of a material selected from the group consisting of nickel, chromium, nickel-chromium alloy, nickel-copper alloy, silver, aluminum, and combinations thereof.

27. The ceramic heat-sensitive device of claim 16, wherein the ceramic body comprises a first constituent and a second constituent, wherein:
the first constituent comprises barium, strontium, calcium, and a first trace element;
the second constituent comprises titanium, manganese, and a second trace element;
the first trace element and the second trace element are selected from the group consisting of ytterbium, lanthanum, cerium, antimony, praseodymium, neodymium, samarium, europium, gadolinium, tantalum, erbium, thulium, and combinations thereof; and
an electrical resistivity of the ceramic body is below 10 Ω·cm.

28. The ceramic heat-sensitive device of claim 27, wherein the total number of moles of barium, strontium, calcium, and the first trace element is taken as 100%, wherein:
strontium accounts for 20% to 25%;
calcium accounts for 4.5% to 5%; and
the first trace element accounts for 0.13% to 0.17%, whereby a Curie point of the ceramic body ranges from 85° C. to 91° C.

29. The ceramic heat-sensitive device of claim 27, wherein the total number of moles of titanium, manganese, and the second trace element is taken as 100%, wherein:
manganese accounts for 0.01% to 0.03%; and
the second trace element accounts for 0.02% to 0.04%.

30. The ceramic heat-sensitive device of claim 29, wherein:
the ceramic body has a first electrical resistance at 25° C.;
the ceramic body has a second electrical resistance at 125° C.; and
a value of the second electrical resistance divided by the first electrical resistance is at least 10.
